(19) United States
(12) Patent Application Publication
(10) Pub. No.: US 2002/0007303 A1
(43) Pub. Date: Jan. 17, 2002

(54) System for conducting electronic surveys

(76) Inventors: Brent D. Brookler, Seattle, WA (US); Brian E. Levin, Seattle, WA (US); Peter A. Loos, Seabeck, WA (US)

Correspondence Address: John F. Letchford, Klehr, Harrison, Harvey, Branzburg, & Ellers, 260 South Broad Street, Philadelphia, PA, 19102, US

(21) Appl. No.: 09/845,700

(22) Filed: Apr. 30, 2001

Related U.S. Application Data
(60) Provisional application No. 60/201,011, filed on May 1, 2000.

(51) Int. Cl. G06F 17/60

(52) U.S. Cl. 705/10

(57) ABSTRACT

A system for simultaneous surveying and data collection from multiple types of electronic communication devices. The invention provides an apparatus and process for (1) creating a survey, (2) simultaneously publishing the survey to respondents via a plurality of types of electronic communications devices, and (3) making the results of the survey available to the creator of the survey via communications devices of the creator's choice.

### CROSS-REFERENCE TO RELATED APPLICATION(S)

This application claims the benefit of U.S. Provisional Application No. 60/201,011, filed May 1, 2000.

### FIELD OF THE INVENTION

The present invention relates in general to a system including apparatus and methods for conducting surveys and, more particularly, to an electronic survey conducting system simultaneously operable on many kinds of electronic communications devices, including wireless devices.

### BACKGROUND OF THE INVENTION

Surveying public opinion and thoughts has been done for a long period of time. Generally, the techniques for soliciting opinions have improved with improving technology, starting with paper and mail and progressing to telephone surveys and solicitations. Currently, the proliferation of communications media and devices has greatly expanded the opportunities and ways by which to survey targeted groups for their opinions and thoughts. For example, even exclusively within the context of Internet surveying, there are multiple means by which users or respondents communicate with the Internet and can respond to Internet surveys. However, as presently conducted, Internet surveys are device-specific. That is, they are designed to be carried out using only a single one of several classes of Internet-compatible communications devices, e.g., a personal computer (PC) or a wireless device such as a personal digital assistant (PDA) or cellular telephone (cell phone). This limits the scope of the survey to only one means of connectivity to a particular network. This may be problematic for a potential survey respondent who possesses only one type of communications device or who possesses more than one type of communications device but, because of preference, habit or necessity, tends to use one type of device more frequently, oftentimes considerably more frequently, than the others. Under these circumstances, such a potential respondent may not be captured within the pool of respondents whose input may be of importance to the survey administrator. This reduces the number of potential respondents that may be incorporated into the survey which, in turn, reduces the reliability of the survey results. Therefore, there is a need in the art for a system including methods and apparatus for conducting a survey with respondents having multiple means of connectivity to a particular network, whereby the respondents may participate in the survey regardless of the means by which they choose to connect to the network.

### SUMMARY OF THE INVENTION

The present invention provides a system including methods and apparatus for simultaneous surveying and data collection from multiple types of electronic communication devices. The invention provides a process for (1) creating a survey, (2) simultaneously publishing the survey to respondents via a plurality of types of electronic communications devices, and (3) making the results of the survey available to the creator of the survey via communications devices of the creator's choice. More particularly, the process comprises

(a) creating a survey by writing the survey materials and placing the survey materials into a first database as survey input data;

(b) wrapping each element of survey input data with desired markup language tags defined in a schema to provide a collection of data in a markup language-wrapped document;

(c) publishing the markup language-wrapped document parsed using the survey input data, wherein the survey input data are in the form of a collection of markup language-wrapped data, by parsing the markup language-wrapped data against the schema;

(d) sending the parsed, markup language-wrapped data in output defined style sheets to a plurality of types of interface devices via suitable communications networks;

(e) receiving survey response data in a second database via suitable communications networks; and

(f) analyzing and publishing the retrieved data by wrapping the retrieved data in a desired markup language text.

Preferably, the markup language-wrapped data are further validated against a pre-defined schema. Additionally, the analyzed data is preferably further parsed against a second schema to enable the analyzed data to be accessed by at least one interface device type specified by a creator of the survey.

The invention further includes a survey publishing system for simultaneous surveying and data collection from multiple interface device types. The publishing system enables a party to create a survey and publish the survey to potential survey respondents having multiple interface device types. Additionally, the publishing system gathers and analyzes the survey results and makes the results available to the survey creator in one or more formats compatible with interface device types of the survey creator's choosing.

The survey publishing system comprises a survey input database into which the survey creator inputs and stores all relevant information associated with particular survey (including, without limitation, the question(s) to be answered by the respondents, the types of interface devices the surveyor chooses to receive the survey, and the time or numerical response limits of the survey). The system further comprises a publishing engine for transmitting the surveys stored in the survey input database in the desired formats to the desired interface devices. Upon receipt of the surveys, the respondents answer the questions posed therein and transmit their responses to a survey results database and analysis engine of the survey publishing system. From the survey results database and analysis engine, the analyzed survey results are sent to the publishing engine where they may be retrieved by the surveyors using the interface devices of their choice.

According to the present invention, therefore, surveyors can create surveys that can simultaneously reach multiple types of interface devices; respondents using a variety of interface devices may participate in a survey; and, surveyors receive more complete and meaningful survey information than heretofore available using conventional single device surveys.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments shown, by way of example only, in the accompanying drawings wherein:

FIG. 1 is a symbolic diagram of the essential components of the survey publishing system according to the present invention and the overall process enabled by the system;

FIG. 2 is a flowchart illustrating the process by which a surveyor creates a survey;

FIG. 3 is a flowchart illustrating the process by which the survey is published to the respondents who will participate in the survey;

FIG. 4 is a flowchart illustrating the process by which the survey is implemented and the data is collected from the respondents;

FIG. 5 is a drawing showing the data analysis process used to analyze the data collected as shown in FIG. 4; and

FIG. 6 is a drawing showing the process by which the results of the survey are published to the party who originally requested the survey.

### DETAILED DESCRIPTION OF THE INVENTION

As used herein, the following terms shall have the meanings set forth below.

Schema is a document that defines tags.

Tags are definitions or titles of data specific for a particular user/surveyor agent.

Parser Engine parses data according to tags defined in the schema.

Style Sheet is an output specification corresponding to the display parameters of an output or interface device.

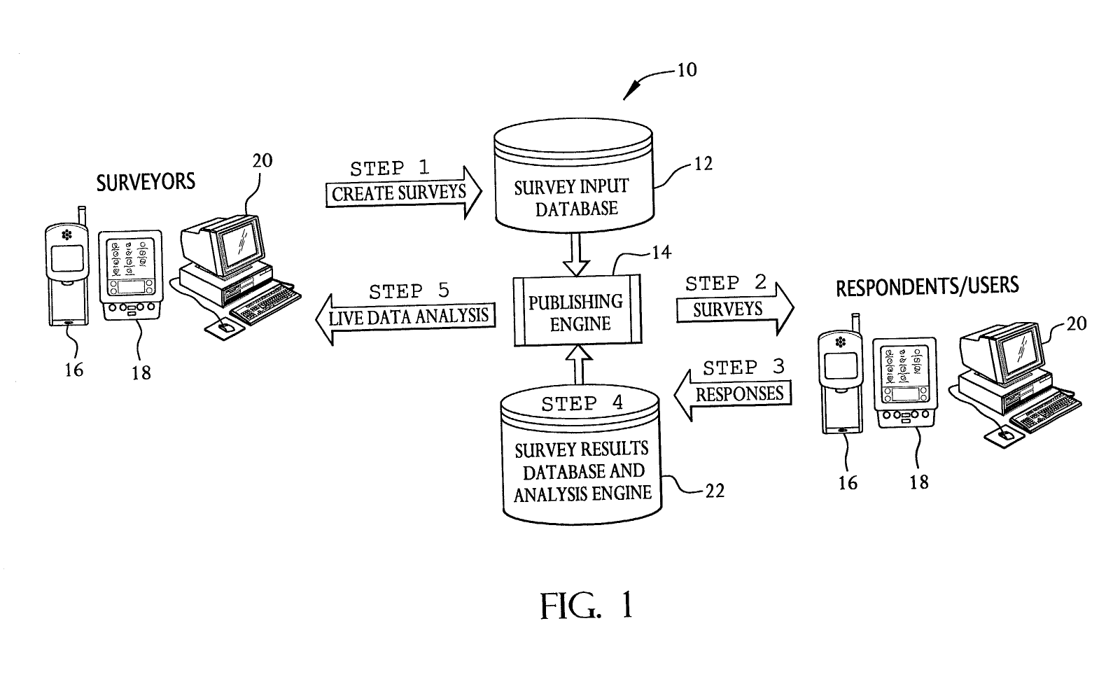

Referring to the drawings, wherein like or similar references designate like or similar elements throughout the several views, there is shown in FIG. 1 the overall system according to the invention, including apparatus and process, for creating and publishing electronic surveys and for collecting and analyzing data generated by the surveys. In FIG. 1 the survey creators or surveyors are depicted on the left side and the users, or survey respondents, on the right side. The overall process is generally represented as follows:

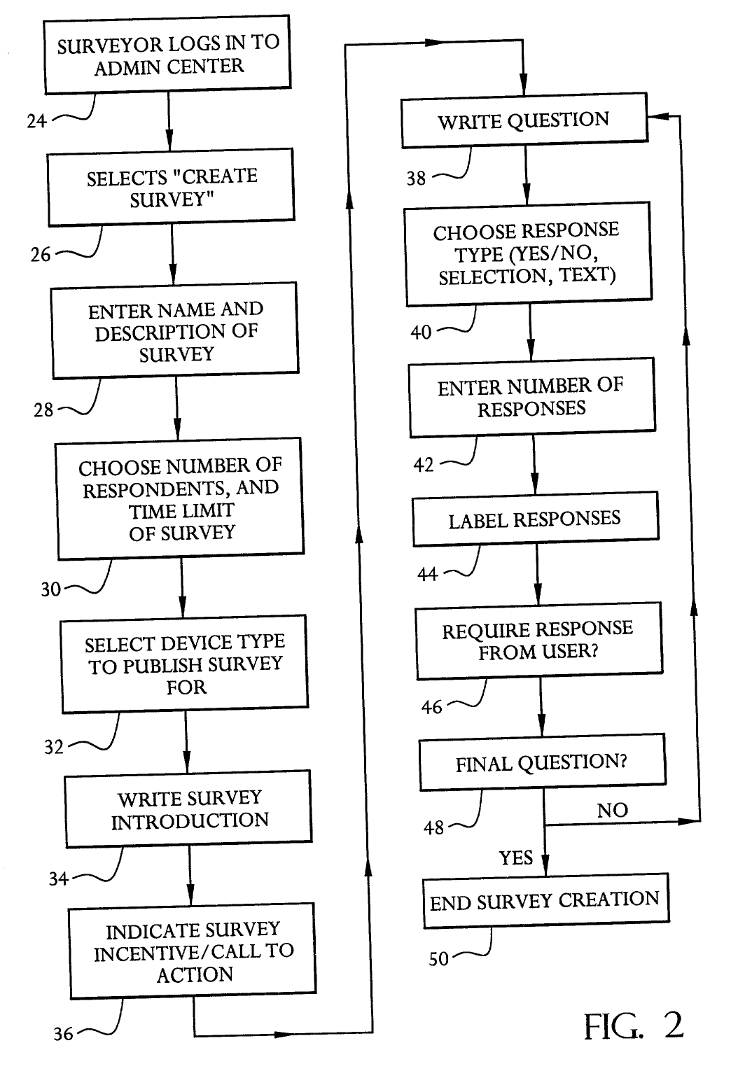

Step 1: Survey Creation: The surveyor creates a survey using a survey publishing system which is generally indicated by reference numeral 10. During this step, the surveyor determines, inter alia, the type of survey, the number of respondents desired (or, alternatively, the time limit of survey), and desired interface device types on which to publish the survey on (PC, PDA, cell phone, etc.). Also, as will be more readily appreciated by reference to FIG. 2 and its corresponding description, it is at this stage the survey questions are created by the surveyor. The survey information, including the questions, is stored in dedicated database tables in a survey input database 12, where it can be accessed for later use.

Step 2: Survey Publishing: This step involves taking the initial survey data (questions, types, formats) and publishing them via suitable communications networks (wired or wireless) to various types of user/respondent computing or interface devices. Since there are many different device types, i.e., cell phone, PDA, PC, as well as future devices, that may be capable of implementing the present survey system, the formatting must be different for each type of device. As described hereinafter, a publishing engine 14 of survey publishing system 10 will determine which type of respondent interface device (e.g., cell phone 16, PDA 18 or PC 20) is making a request to respond to a survey. Thereafter, publishing engine 12 will publish the survey over to interface device 16, 18 or 20 over an appropriate communications network (wired or wireless) in the appropriate format for that device.

Step 3: Survey Implementation/Data Collection: At this step, the user responds to the survey questions. The response data is transmitted by the survey respondent over the communications network and is collected at a survey results database and analysis engine 22 of survey publishing system 10. This data includes not only the responses to the survey questions, but user data, such as interface device type, and session information, such as length of survey, time of day, and so on.

Step 4: Data Analysis: Once the response data is collected from a respondent's device, the unprocessed survey data is stored in “raw data” database tables of the survey results database. Statistical analysis is then performed on the raw data by the data analysis engine using stored procedures. The type of analysis is specified by the surveyor and analyzed or processed data results are stored in dedicated “analyzed data” database tables.

Step 5: Analyzed Data Publishing and Reporting: Once the data has been analyzed in accordance with parameters prescribed by the surveyor, reports and results are published by publishing engine 14. As specified by the surveyor, publishing engine 14 makes the survey results and reports available for access by the surveyor via one or more interface devices (e.g., cell phone 16, PDA 18 or PC 20). The survey results may be “pushed” by the survey publishing system server to the surveyor in the manner known in the art. Alternatively, and preferably, the survey results and reports may passively reside on the survey publishing system server where they may be “pulled” or retrieved by the surveyor. In the latter case, survey publishing system 10 may be programmed to notify the surveyor via electronic mail message or otherwise that the survey results are available for access. It will be understood that publishing engine 14 will publish different levels and depth of data according to the interface device specified by the surveyor to receive the data, e.g., a cell phone will only get high level reports, whereas a PC will receive detailed analysis.

FIG. 2 illustrates the survey creation process. This process preferably occurs in a secure administration environment, such as a password protected web site, where the surveyor can access all of its pertinent information, and build surveys to be presented to users. The survey creation process is outlined below.

Initially, at step 24, the surveyor logs in to the administration center's secure website, enters the appropriate user and password information to gain access to the survey publishing system 10 and, upon gaining such access, selects “Create Survey” at step 26. Thereafter, the surveyor determines all the variable factors of the survey. The variable factors include:

Name of survey (step 28)—quite simply, the title of the survey that can be used by both the surveyor and the respondents to refer to the survey.

Description of survey (step 28)—information provided by the surveyor for the purpose of describing the survey in a text field.

Number of respondents desired (step 30)—at this step, the surveyor selects how many survey responses it wants to limit the survey to. The surveyor may also select the option of “no limit.”

Time limit (step 30)—the surveyor selects an ending date/time for the poll.

Priority: time or number of responses (step 30)—the surveyor chooses which should take priority, the time limit of the survey or the number of responses.

Type of devices desired (step 32)—the surveyor selects what kinds of interface devices they want to be able to respond to the survey. This will determine how and on which devices the poll will be published, e.g., cell phone, PDA, PC, as well as future devices.

Survey Introduction (step 34)—this enables the surveyor to input a narrative introduction to the survey including information such as the purpose of the survey and the sorts of information that the surveyor is seeking to collect. The survey introduction appears as text area that users will see on their interface devices when they begin to take the survey.

Survey Incentive/Call to Action (step 36)—at this point, if desired, the surveyor can create an incentive for a user who responds to the survey. It may be in the form of a text field to be entered by the client and can be presented as a discount, offer, or a uniform resource locator (URL) or hyperlink that can serve as a call to action.

Write question (step 38)—this is a text area that enables the surveyor to enter a question to be posed to the user.

Choose response type (step 40)—this step allows the surveyor to select the type of responses for the question, e.g., Yes/No, True/false, single selections, multiple selections, text boxes, numerical rating, numerical, Agree/Disagree scale, and so on.

Enter number of responses (step 42)—if the chosen response type is not Yes/No or True/False, then the surveyor will specify how many responses to choose from for that question.

Label responses (step 44)—this is a text area that enables the surveyor to provide descriptive text for the different responses based on the different question types.

Require response from user? (step 46)—this step enables the surveyor to specify whether a response to a particular question is mandatory.

Final question? (step 48)—if there are more questions to be created, the surveyor returns to write question step 38 and repeats steps 38-46). If there are no more questions to be added to the survey, the surveyor so indicates and the survey creation process terminates at step 50.

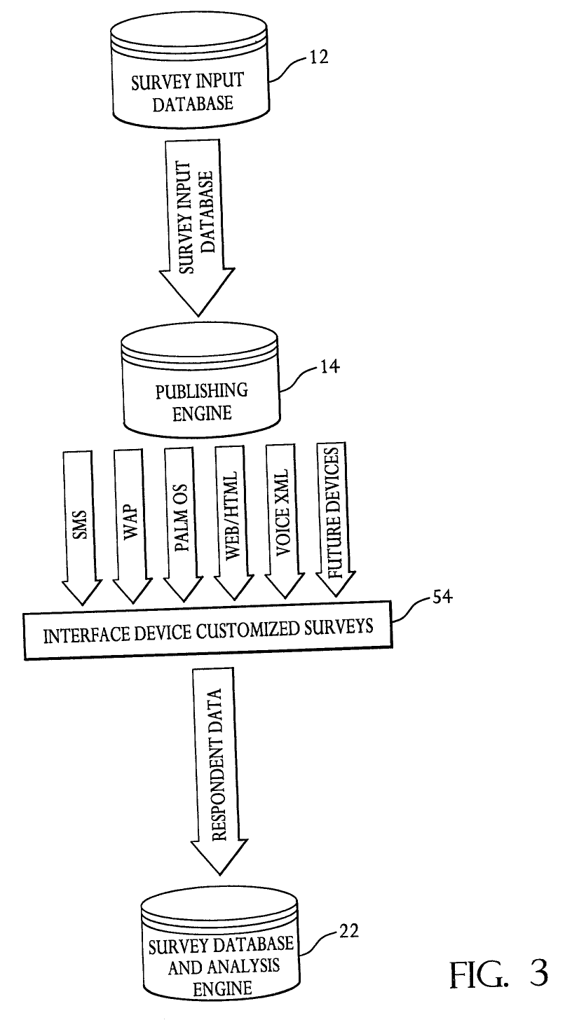

FIG. 3 illustrates the process of publishing the survey created according to FIG. 2. Upon completion of creation of a survey, the survey parameters are stored in dedicated database tables in survey input database 12. Publishing engine 14 thereafter publishes or “pushes” the survey in the appropriate formats to the interface device types targeted for the survey. To do so, survey publishing system 10 employs a markup language translation layer 52 that wraps each element of survey input data with markup tags defined in a schema to provide a collection of data in a markup language-wrapped document. The markup language translation layer 52 preferably utilizes a plurality of markup language technologies in order to leverage the survey data to multiple types of interface devices. According to a presently preferred embodiment, markup language translation layer 52 utilizes extensible markup language (XML), standard query language (SQL) and dynamic page creation technologies such as JAVA and PERL to achieve the desired objectives. It will be understood that markup language translation layer 52 may include any combination of the foregoing alone or in combination with one or more of hypertext markup language (HTML), wireless markup language (WML), user interface markup language (UIML) or other form of presently existing or yet to be developed standard generalized markup language (SGML) that may be used to realize the objectives of the present invention. Most preferably, the markup language translation layer 52 is preferably readily programmable or configurable to accommodate any markup languages that may be required to push survey data in survey input database 12 in formats appropriate to all presently known and hereinafter developed interface devices.

According to a presently preferred embodiment, data collected during the survey building or creation process is stored in the survey input database 12 and translated to XML for optimal portability vis-a-vis presently available interface devices. Using publishing engine 14, the surveyor may opt to publish the survey immediately after creation and simultaneously to all types of devices. In the alternative, the surveyor may choose to delay the launch of the survey or stagger the times at which the survey information is published to the various interface devices selected for participation in the survey. By way of example, publishing engine 14 may at present be configured to publish to cell phones using the wireless application protocol (WAP) (which incorporates WML), short messaging service (SMS) using the global system for mobile communication (GSM) or VoiceXML. Likewise, publishing engine may also publish to computer browsers via HTML and to Palm® devices or other PDAs using PalmOS or other suitable PDA operating systems (or SMS) depending on where the surveyor wishes the poll to be published.

Preferably, with one data set, all Internet appliances or interface devices are deployed ubiquitously. The following is a brief discussion of the formats having the broadest compatibility with presently available interface device technology.

WAP

WAP is primarily WML and WML script, but many different cell phones (User Agents) require slight modifications to the WAP standard. Preferably, markup language translation layer 52 includes a database of User Agents and their respective differences versus standard WAP. The present inventors have discovered that by using XML, customized style sheets may be created for each User Agent to ensure that all devices will work as designed.

HTML

For publishing to HTML, it is preferable to use HTML 3.2 to allow some retroactive compatibility with older versions of web browsers. In any event, HTML surveys should be 100% compliant with Netscape Navigator® 4.0 and later and Microsoft Internet Explorer® 4.0 and later, which presently account for more than 90% of the browser market.

PalmOS

For PalmOS, publishing engine 14 should be capable of publish using the current Palm-compatible formats including Web Clipping and Palm Query Application (PQA). Using XML or other SGML, it would preferable to create versions of PDA operating systems that are compatible with Palm® and other PDAs.

Once pushed to the desired interface devices, the formatted surveys reside as customized surveys 54 on the various devices. The respondents may then participate in the surveys and transmit their respondent data over the appropriate communication networks (wired or wireless) to the survey results database and analysis engine 22.

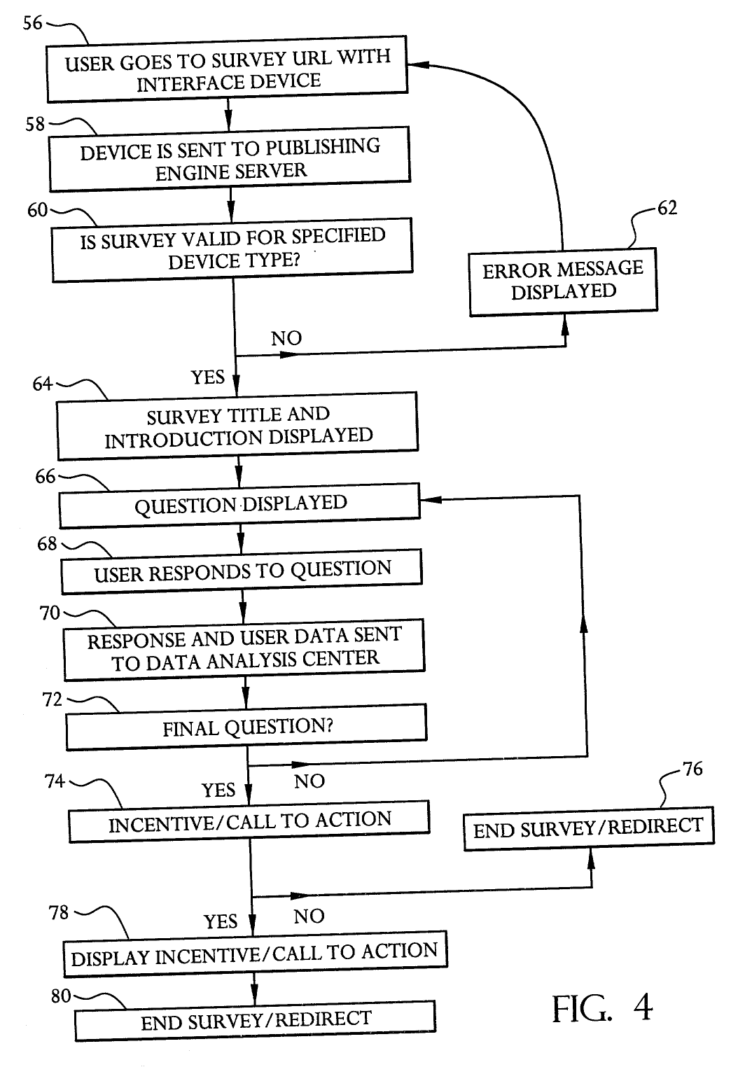

FIG. 4 illustrates the process by which respondents reply to the survey. The process begins when the user, at step 56, directs his or her interface device to a URL associated with the stored survey. Data is collected in three distinct data streams during the survey implementation/data collection process—user profile, user session, and user response. To verify a particular device type, at step 58 data identifying the responding device is transmitted to the publishing engine 14. At the publishing engine, the device type is compared, at step 60, against a database table for acceptable device types. If the device is not found to be valid, an error message is displayed, at step 62, on the user's device at which point the user may again to participate in the survey at step 56.

If the user's device is determined to be valid, the survey begins. Initially, at step 64, the survey title and description are displayed, followed at step 66 by the first survey question 66. At step 68 the user responds to the first question and the response and user data is transmitted, at step 70, to the survey results and analysis engine 22. The survey questions and user responses thereto continue to be generated in turn until the final question is displayed and responded to at step 72. At this point, the system logic checks, at step 74, to determine whether the surveyor has not specified an incentive/call to action to motivate the user to respond to the survey. If not, the survey ends at step 76, and the user is optionally redirected to the application that the user was using, if any, prior participating in the survey. If so, the incentive/call to action is displayed at step 78 and the survey is terminated at step 80. Again, the user may be optionally redirected to the application that the user was using, if any, prior participating in the survey.

Session data is preferably gathered for each user that visits the survey, whether they personalize a user profile or not. Session data desirably includes login time, click stream, time spent on each question, and logout time. Anonymous user profiles are preferably created for each new visit to the survey, unless the user establishes a personalized profile and logs into the survey with a password. All profiles are recorded as a unique numeric value and are used to correlate session data with unique visits. Personalized profiles can contain a variety of additional personal information including e-mail/device address, zip code, age, gender and/or other relevant information.

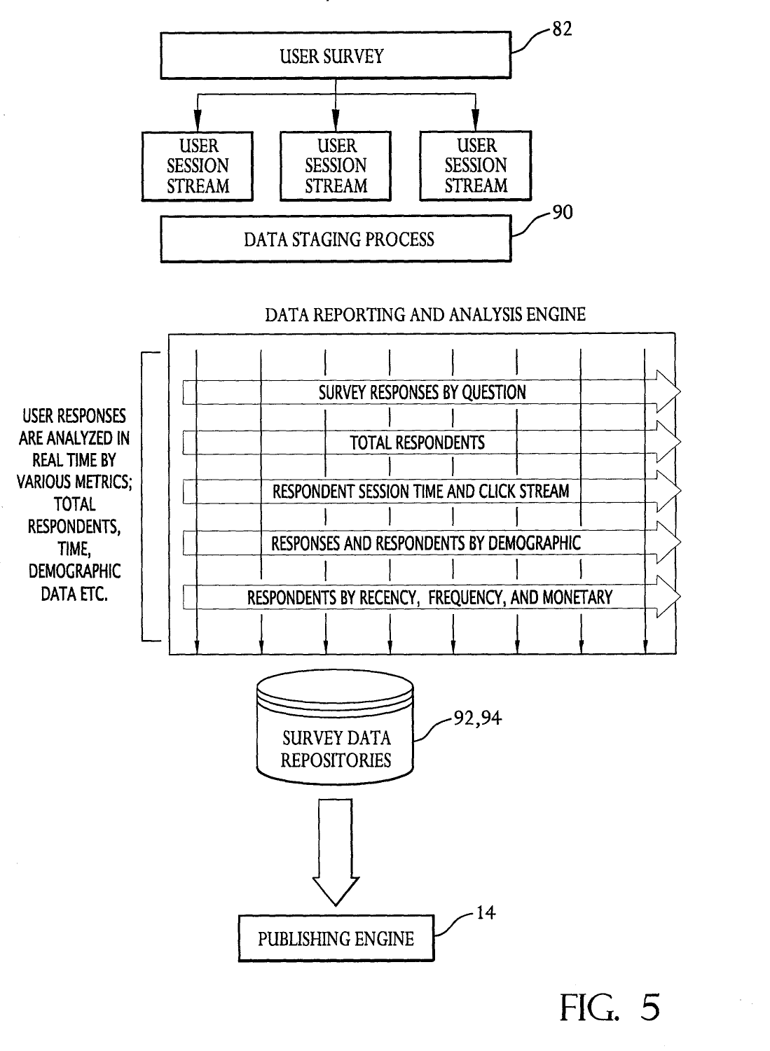

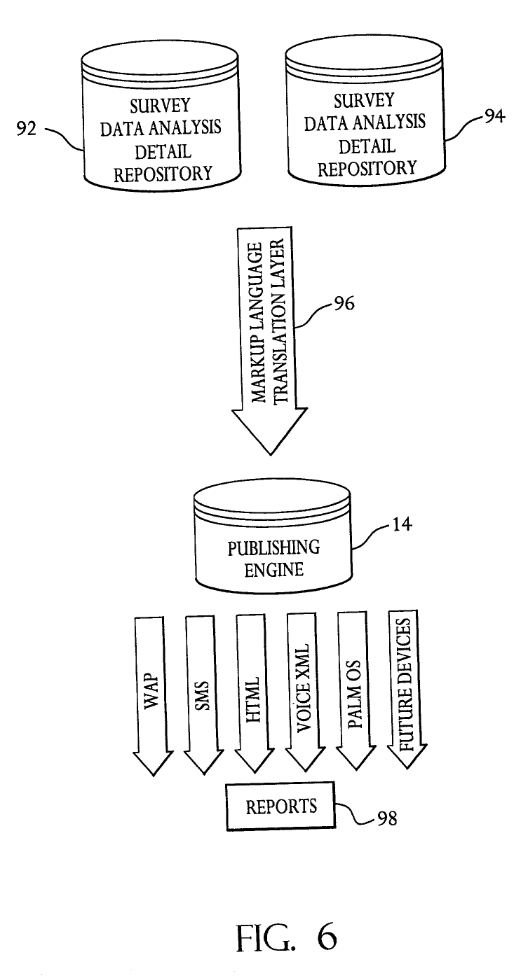

User responses to the survey questions are collected and recorded with the unique numeric value of the user profile (anonymous or personalized) to allow for the correlation of user session, profile, and response data. The process of collecting the data from the user is represented in FIGS. 5 and 6.

FIG. 5 illustrates the process by which the data collected from survey respondents is analyzed. The data analysis process is essential for providing value to the surveyors creating the polls in that it offers them real time top level results and detailed analysis and reporting.

Using data compression to speed analysis and delivery of results to publishing engine 14 ensures real time results. The completed user survey is transmitted to the publishing engine 14 in a user session stream 84, a user profile stream 86 and a user response stream 88. These data streams are compiled in a data staging process 90. At this point the analysis engine 22 analyzes the data in accordance with reporting requirements established by the surveyor. The analysis engine 22 may analyze the response data in accordance with any criteria chosen by the surveyor, for example, survey responses by question, totals responses, respondent session time and click stream, responses and responses by demographic, and respondents by recency, frequency and monetary (discussed below). Depending on the device used to view published results, additional drill-down and drill-through requests are supported using common key elements in survey data analysis repositories 92 and 94, discussed below. The functions of the data staging process 88, analysis engine 22 and survey data repositories 92,94 are as follows.

Data Staging Process

As the data is received from the three data streams 84, 86 and 88, it is immediately consumed by the data staging process 90. The data staging process 90 cleanses, compresses, and prioritizes the data received to ensure efficient processing by the analysis engine 22.

Analysis Engine

Surveyor reporting requirements, which are established during survey creation, are applied to the data received from the data staging process 90. Recognizing the priority of each piece of data, the analysis engine 22 produces new dimensions and updates existing dimensions as required, thereby producing detail and aggregate (summary) data streams to the survey data analysis repositories 92 and 94, respectively.

Data Repositories

Survey data analysis detail and aggregate repositories 92,94 are inextricably linked through session, profile, and response data. Strong validation combined with indexing and performance tuning provides a reliable and efficient data store to be used by the publishing engine 14.

FIG. 6 illustrates the process by which the results of a survey are reported to the surveyor who requested them. The analyzed data that results from the surveys will be transmitted to the surveyor's administration area, where surveys are created. The process is similar to the publishing of created surveys to users, except the information is published to the surveyor's administration area of publishing engine 14. The process is outlined below.

The data contained in data repositories 92,94 is converted by a markup language translation layer 96 similar in content and function to markup language translation layer 52 discussed above. That is, markup language translation layer 96 wraps each element of survey response data with markup tags defined in a schema to provide a collection of data in a markup language-wrapped document. Standard and/or customized reports 98 prescribed by the surveyor may be provided to the surveyor in WAP, HTML, PalmOS, SMS, VoiceXML or other formats and style sheets suitable to the surveyor's specified interface device(s), whether presently existing or hereinafter developed. Standard reports may include one or more of the following: total number of respondents to survey, percentage of answers by question, average percentage of questions answered, average session length, average time to respond to each answer, total number of respondents who responded to call to action, and total number of call to actions served.

Each of the reports will may also be sorted by date/time, by RFM (R=Recency—how recently did the profile (user) visit; F=Frequency—how frequently has the profile visited; M=Monetary—how much in total has the profile spent with the surveyor and/or provided benefit to the surveyor), as well as by gender, gender by age group, age group, home zip code, location (cell), and device type used to respond to the survey.

Although the following generally sets forth the overall survey conducting process of the present invention as it would be conducted using an XML format, it is contemplated that the present invention may be used in conjunction with any presently known markup language formats currently known or developed in the future. More particularly, the process comprises

(a) creating a survey by writing the survey materials and placing the survey materials into a first database as survey input data;

(b) wrapping each element of survey input data with desired markup language tags (e.g., XML tags) defined in a schema to provide a collection of data in a markup language-wrapped (e.g., XML-wrapped) document;

(c) publishing the markup language (e.g., XML) wrapped document, wherein the survey input data are in the form of a collection of markup language-wrapped (e.g., XML-wrapped) data, by parsing the markup language-wrapped (e.g., XML-wrapped) data against the schema;

(d) sending the parsed, markup language-wrapped (e.g., XML-wrapped) data in output defined style sheets to a plurality of types of interface devices via suitable communications networks;

(e) receiving survey response data in a second database via suitable communications networks;

(f) analyzing the received data; and

(g) publishing the received data by wrapping the received data in a desired markup language (e.g., an XML) document.

Preferably, the markup language-wrapped data are further validated against a pre-defined schema. Additionally, the analyzed data is preferably further parsed against a second schema to enable the analyzed data to be accessed by at least one interface device type specified by a creator of the survey.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. A process for conducting an electronic survey, said process comprising the steps of:
creating an electronic survey;
sending said survey to a plurality of users having different types of electronic interface devices; and
accessing user data generated in response to said survey using at least one type of electronic interface device.

2. The process of claim 1 further comprising accessing said user data using plurality of types of electronic interface devices.

3. The process of claim 1 further comprising storing said survey on a first database and receiving said user data on a second database.

4. The process of claim 3 further comprising analyzing said user data prior to said step of accessing.

5. The process of claim 4 wherein said step of analyzing comprises analyzing said user data in accordance with criteria established by a creator of said survey.

6. A process for conducting an electronic survey, said process comprising the steps of:
(a) creating a survey by writing the survey materials and placing the survey materials into a first database as survey input data;
(b) wrapping each element of said survey input data with markup language tags defined in a schema to provide a collection of data in a markup language-wrapped document;
(c) publishing said markup language-wrapped document, wherein said survey input data are in the form of a collection of markup language-wrapped data, by parsing said markup language-wrapped data against said schema;
(d) sending the parsed, markup language-wrapped data in output defined style sheets to a plurality of types of interface devices via suitable communications networks;
(e) receiving survey response data in a second database via suitable communications networks;
(f) publishing the received data by wrapping the received data in a desired markup language document.

7. The process of claim 6 further comprising accessing said received data using at least one type of electronic interface device.

8. The process of claim 6 further comprising accessing said user data using plurality of types of electronic interface devices.

9. The process of claim 6 wherein said step of accessing is performed by a creator of said survey.

10. The process of claim 6 further comprising analyzing the received data prior to publishing the received data.

11. The process of claim 6 wherein said markup language-wrapped data are further validated against a predefined schema.

12. The process of claim 6 wherein said received data is further parsed against a second schema to enable the analyzed data to be accessed by at least one interface device type specified by a creator of the survey.

13. The process of claim 6 wherein said markup language is extensible markup language.

14. Apparatus for conducting an electronic survey, said apparatus comprising:
a first database for storing an electronic survey comprised of survey input data;
a publishing engine for sending said survey to a plurality of users having different types of electronic interface devices via suitable communications networks; and
a second database for receiving survey response data from said electronic interface devices via suitable communications networks, wherein said publishing engine further publishes said survey response data for access by at least one type of electronic interface device.

15. The apparatus of claim 14 further comprising means for analyzing said response data prior to publishing by said publishing engine.

16. The apparatus of claim 15 wherein said analyzing means analyzes said user data in accordance with criteria established by a creator of said survey.

17. The apparatus of claim 14 wherein, prior to sending said survey to a plurality of users, said publishing engine wraps each element of said survey input data with markup language tags defined in a schema to provide a collection of data in a markup language-wrapped document.

18. The apparatus of claim 14 wherein, prior to publishing said survey response data, said publishing engine wraps each element of said survey response data with markup language tags defined in a schema to provide a collection of data in a markup language-wrapped document.

19. The apparatus of claim 17 wherein said markup language is extensible markup language.

20. The apparatus of claim 18 wherein said markup language is extensible markup language.
